(19) United States
(12) Patent Application Publication
(10) Pub. No.: US 2017/0149909 A1
(43) Pub. Date: May 25, 2017

(54) OUTPUT CONTENT AUTO-CUSTOMISATION HOST DEVICE, METHOD AND SYSTEM THEREFOR

(71) Applicant: Herbert LEE YING CHIU, Wan Chai (HK)

(72) Inventor: Herbert LEE YING CHIU, Wan Chai (HK)

(21) Appl. No.: 15/190,445

(22) Filed: Jun. 23, 2016

(30) Foreign Application Priority Data
Nov. 20, 2015 (HK) 15111492.3

(51) Int. Cl. H04L 29/08; H04L 12/26

(52) U.S. Cl. CPC H04L 67/18; H04L 43/10; H04L 67/10; H04L 43/106

(57) ABSTRACT

A host device for automatically customizing output of at least one content within a predefined geographical location includes a storage module for storing categorized content received from server in the host device locally; a transceiver module for transmitting ping signals to the terminal device at a time interval and for collecting one or more user particulars from the terminal device; an eligible device identification module for defining criteria for identifying the eligible terminal device; a prioritisation module for prioritising the categorized content stored locally in the host device based upon a matching fraction of a category of the categorized content relating to number of the eligible terminal device having a user particular which matches a category of the categorized content; a selection module for selecting the content based upon the prioritising result; and a display module for displaying the selected content, and a method and a system thereof.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

This invention relates to a host device for automatically customizing output of at least one content within a predefined geographical location, and a method and a system therefor.

2. Description of Related Art Including Information Disclosed Under 37 CFR 1.97 and 37 CFR 1.98.

WO 2014159410 A1 discloses a real-time and privacy-preserving method for delivering personalized information to a user within a specific geographical location. The method comprises the steps of: storing information specific to a user in a database maintained by a centralized brokerage service; transmitting a user initiated request to the centralized brokerage service to provide a listing of products and services offered by retailers or third parties located in the approximate current geographical vicinity of the user; utilizing the stored information of the user to generate a personalized listing of products and services offered within the approximate current geographical vicinity of the user; and sending the generated personalized listing to the user.

US 20140214537 A1 discloses an advertisement providing system. The system includes a first server configured to generate and store user models of interest, based on behaviour history information of a user terminal and advertisement-of-interest selection conditions input by a user; a second server configured to generate and store target user attribute models, based on advertisement information and target user selection conditions provided from an advertisement provider; and a third server configured to detect a model by detecting the user models of interest and the target user attribute models based on user information when the user information is transmitted from the user terminal, and recommending an advertisement related to the detected model to the user terminal.

Existing systems and methods suffer from a number of drawbacks. They do not provide a host device to which select contents derived from a server can be stored and outputted. Absence of the host device gives rise to a need for a cloud server in which the contents can be stored. The need incurs cost for streaming data from the cloud server to the host device. Also, the cloud storage requires fees to maintain. Furthermore, the existing systems and methods do not distinguish eligible devices from passer-by devices, rendering the select contents less accurate in their match to particulars of audience. Moreover, the existing systems and methods targets at the interest of individual user, rather than a group of users located within a specific geographical location. As individual user may go and leave a location such as shopping arcade quickly, instead of focusing on individual user only, displaying contents which well suits the interests of majority of audience located within a specific geographical location at a particular time increases advertising effectiveness.

### BRIEF SUMMARY OF THE INVENTION

One object of the present invention is the use of a wireless signal for messaging, display promotion, or transmitting announcement, where it can be targeted to a choice of specific type of audience through their mobile devices.

Another object of the present invention is the process of prioritization to be executed locally on the host and displaying the results of the process, which in this process the host able to select or nominate the most suitable advertisements for the targeted audiences within a location, hence able to increase the effectiveness of the advertisement to the targeted audiences within that location.

According to the invention, the drawbacks are overcome and improvements are achieved in a host device for automatically customizing and displaying output of at least one content within a predefined geographical location, comprising: a storage module for storing categorized content received from server in said host device locally; a transceiver module for transmitting ping signals to terminal device at a time interval and for collecting one or more user particulars from said terminal device; an eligible device identification module for defining criteria for identifying eligible terminal device; a prioritization module for prioritizing the categorized content stored locally in said host device based upon a matching fraction of a category of said categorized content relating to number of said eligible terminal device having a user particular which matches a category of the categorized content; a selection module for selecting said content based upon said prioritizing result; and a display module for displaying said selected content.

Preferably, the storage module is configured to receive categorized content from server through internet at any time so as to allow local storage of up-to-date categorized content. The storage module may also be configured to receive categorized content from cloud server wirelessly.

Preferably, the categorized content comprises at least one of audio, visual and audiovisual content. Such audio, visual or audiovisual content are at least one of television commercials, event, lifestyle information or any combination thereof.

Advantageously, the transceiver module is configured to transmit at a time interval of 5-10 minutes.

Preferably, the transceiver module is configured to transmit wireless signal with a pre-determined transmission range. Such wireless signal is by means of Wi-Fi, ultrasound, infra-red or Bluetooth.

Preferably, the terminal device comprises a user interface to fill in information to be transmitted to the host device. The user interface comprises an application with audience demographic form which comprises at least one category information from demographics, preference and hobbies.

Preferably, the said eligible device identification module is configured to record information specific to said terminal device comprising at least one of member ID, international mobile equipment identity and timestamp at which the user logs in to the system.

Preferably, the eligible device identification module is configured to identify eligible terminal device based upon frequency that a terminal device is detected by said ping signals.

Advantageously, the eligible device identification module is configured to identify eligible terminal device based upon further detection by two consecutive ping signals.

Preferably, the prioritization module is configured to calculate the matching fraction of a category of said categorized content by dividing number of said eligible devices having a particular which matches said category by total number of said eligible terminal device.

Preferably, the selection module is configured to select the type of categorized content stored in the storage module.

Further, the host device comprises a requesting module, wherein said requesting module is configured to request the server to deliver categorized content to said storage module.

Preferably, the terminal device is a handheld computing device.

The invention also provides a method for automatically customizing and displaying output of at least one categorized content within a predefined geographical location, comprising steps of: receiving said categorized content from a server by a host device; storing said categorized content locally by the host device using a storage module; identifying at least one eligible terminal device located within said geographical location by the host device using an eligible device identification module; collecting one or more user particulars by the host device from said eligible terminal device using a transceiver module; prioritizing said categorized content based upon a matching fraction of a category of said categorized content relating to number of said eligible terminal device having a user particular which matches a category of the categorized content using a prioritization module in the host device; selecting said categorized content based on said prioritizing result; and outputting said selected content to a display.

Preferably, the step of receiving said categorized content from a server comprises receiving said categorized content at any time from a content server through internet or from a cloud server.

Preferably, the step of identifying at least one eligible terminal device located within said geographical location comprises steps of detecting terminal device by transmitting ping signals within said geographical location at a time interval; recording information specific to said terminal device comprising at least one of member ID, international mobile equipment identity and timestamp at which the user logs in to the system; and identifying eligible terminal device based upon number of times that a terminal device is detected by said ping signals.

Preferably, the step of detecting terminal device by transmitting ping signals comprises transmitting wireless signals with a pre-determined transmission range, wherein said transmitting wireless signals comprises transmitting wireless signals by means of Wi-Fi, ultrasound, infra-red or Bluetooth.

Advantageously, the step of detecting terminal device by transmitting ping signals at a time interval comprises transmitting said ping signals at a time interval of 5 to 10 minutes.

Advantageously, the step of identifying eligible terminal device based upon number of times that a terminal device is detected by said ping signals comprises steps of detecting terminal device in two consecutive pings; and recording said terminal device as an eligible terminal device.

Preferably, the step of collecting one or more user particulars from said eligible terminal device comprises steps of requesting said eligible terminal device to send user particulars inputted by users in interfaces of said eligible terminal device; receiving said user particulars; and recording said user particulars.

Preferably, the step of requesting said eligible terminal device to send user particulars inputted by users in interfaces of said eligible terminal device comprises requesting said eligible terminal device to send information filled in by users in an audience demographic form of an installed application of said eligible terminal device, wherein said receiving said user particulars comprises receiving said user particulars through wireless signals.

Preferably, said requesting said eligible terminal device to send information filled in by users in an audience demographic form comprises requesting said eligible terminal device to send at least one information from demographics, preference and hobbies as defined in said audience demographic form.

Preferably, the matching fraction of a category of said categorized content is calculated by dividing the number of said eligible devices having a particular which matches said category by total number of said eligible terminal device.

Further, the method comprises steps of requesting said server to deliver categorized content to the host device; prioritizing said newly delivered categorized content based upon said user particulars collected; selecting said categorized content based upon said prioritizing result; and outputting said selected content to a display.

Further, the method comprises steps of updating list of eligible terminal device identified at a particular point of time; updating user particulars collected based upon said updated list of eligible terminal device; prioritizing said categorized content based upon said updated user particulars collected; selecting said categorized content based upon said prioritizing result; and outputting said selected content to a display.

The invention also provides a system having at least one terminal device, at least one server and an host device for automatically customizing output of at least one content within a predefined geographical location, wherein said host device comprising: a storage module for storing categorized content received from server in said host device locally; a transceiver module for transmitting signal wirelessly to terminal device located within a transmission range of said host device at a time interval and for collecting one or more user particulars from said terminal device; an eligible device identification module for defining criteria for identifying eligible terminal device; a prioritization module for prioritizing the categorized content stored locally in said host device based upon a matching fraction of a category of said categorized content relating to number of said eligible terminal device having a user particular which matches a category of the categorized content; a selection module for selecting type of content corresponding to the said prioritizing result; and a display module for displaying said selected content.

The present invention consists of features and a combination of parts hereinafter fully described and illustrated in the accompanying drawings, it being understood that various changes in the details may be made without departing from the scope of the invention or sacrificing any of the advantages of the present invention.

### BRIEF DESCRIPTION OF THE SEVERAL VIEWS OF THE DRAWINGS

To further clarify various aspects of some embodiments of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the accompanying drawings in which:

FIG. 1 is a schematic diagram of a system, according to the invention, for outputting to a host device, i.e. an internet television (“TV”), contents derived from a server, corresponding to audience consisting of at least one terminal device, i.e. smartphone, located within a transmission range of the host device.

FIG. 2 is a schematic diagram of the system, showing components of the TV.

FIG. 3 is a flowchart showing a method for outputting to the TV, contents derived from a server, corresponding to audience consisting of at least one smartphone located within a transmission range of the TV.

FIG. 4 illustrates a content priority mechanism chart used to determine the prioritization.

### DETAILED DESCRIPTION OF THE INVENTION

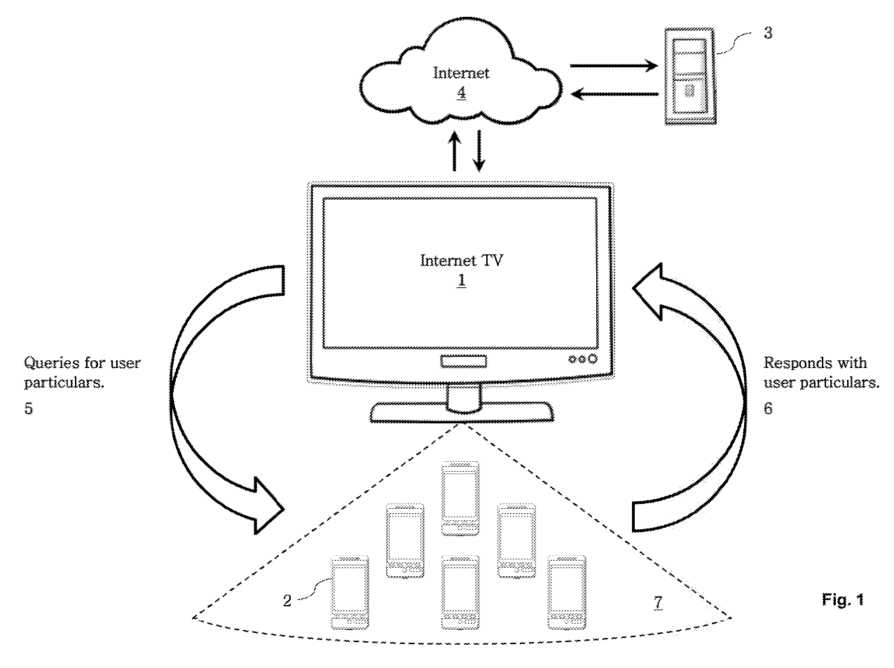

As shown in FIG. 1, the system comprises a host device 1, i.e. an internet television (“TV”), a plurality of terminal devices 2, i.e. smartphones or other handheld computing devices, and a server 3.

The TV 1 is capable of: transmitting signals of queries 5 wirelessly to any one 2 of the smartphones, at a time interval which is adjustable within a range of 5 to 10 minutes, for collecting user particulars of the smartphone 2, wherein said particulars are selected from a group comprising demographics, preference, hobbies, member ID, international mobile equipment identity, and timestamp at which the user logs in to the system; setting criteria for identifying eligible smartphones, wherein the criteria for identifying the eligible smartphones are that the smartphones are located within the transmission range 7 for at least two consecutive queries 5; selecting from the server 3, type of contents corresponding to the particulars collected from the smartphones; requesting the server 3 to deliver to the TV 1, contents corresponding to the smartphones; storing the contents locally; prioritising the categories by sorting the categories according to the a matching fraction, which is a quotient of number of eligible smartphones having a particular which matches the categories, divided by total number of eligible smartphones; and outputting select contents to the TV 1 according to priorities of the categories to which the contents belong.

The smartphone 2 carries an application, through which user fills in the particulars, for example using an audience demographic form (ADF). The smartphone 2 is capable of: receiving the signals of queries 5 in the transmission range 7, e.g. within a range of 5 to 10 metres from the TV 1, and responding wirelessly to the TV 1 with the particulars.

The server 3 is capable of delivering the contents to the TV 1 via a network 4, whenever requested by the TV 1.

On the one hand, the signals 5 can be transmitted by the TV 1 via WiFi, ultrasound, infrared, or Bluetooth. On the other hand, the signals 6 can be responded by the smartphone 2 to the TV 1 via WiFi, ultrasound, infrared, or Bluetooth. The transmission range 7 of the TV 1 can be calculated by the formula for volume of a sphere having a radius of r, i.e. (4/3)πr³. Some examples of the contents are TV commercials provided by TV service operators, and general lifestyle information, like sales promotion of department stores, various types of exhibitions. Some examples of categories are male, female, an age group, a genre of music, and a sport.

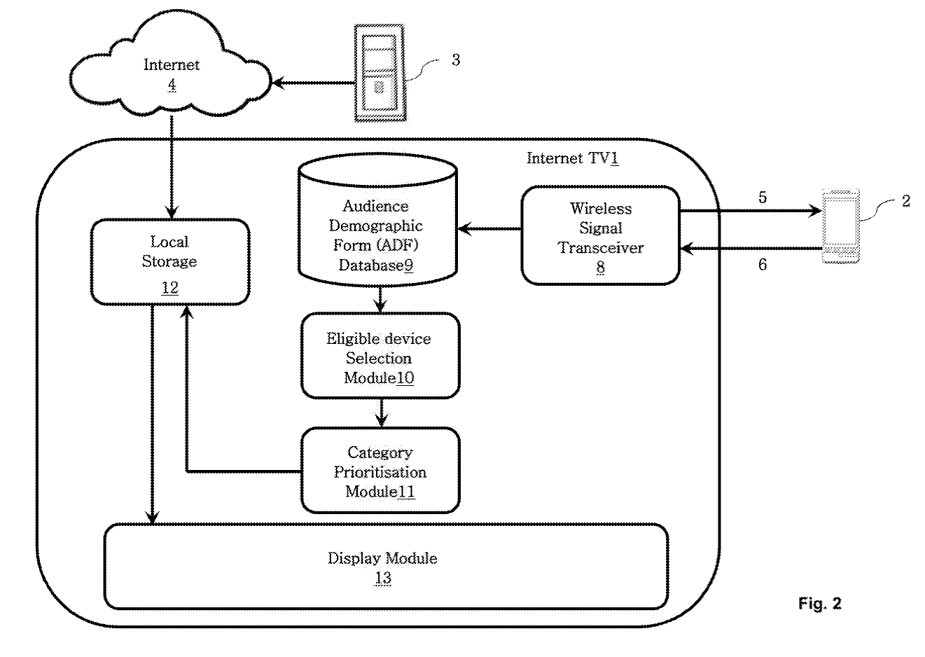

As shown in FIG. 2, the internet TV 1 comprises: a wireless signal transceiver 8 for transmitting signals of queries 5 to the smartphone 2; an audience demographic form (ADF) database 9 for storing the user particulars collected from the smartphone 2; an eligible device selection module 10 for selecting eligible device; a category prioritisation module 11 for prioritising the categories of contents; and a local storage 12 for storing the contents locally; and a display module 13 for outputting select contents. The local storage 12 for storing the contents locally can also be stored in a cloud system or server based storage system.

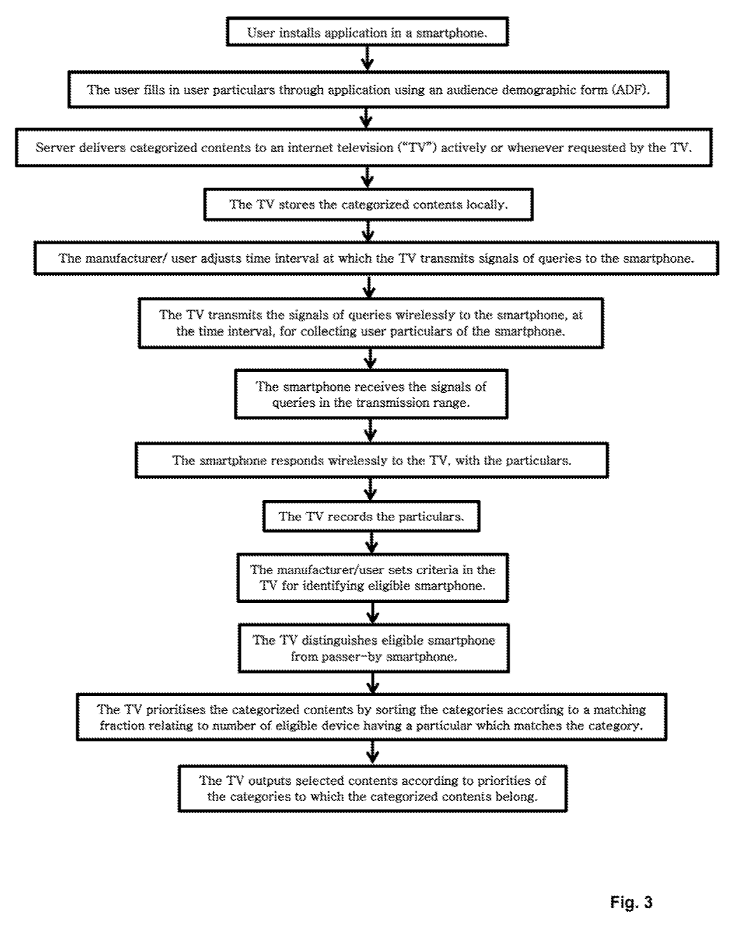

As shown in FIG. 3, the method starts with a first step of installing an application in the smartphone, by the user. This is followed by a second step of filling in the user particulars through the application, using an audience demographic form, by the user. The method is continued by a third step of delivering the contents to the TV, by the server, whenever requested by the TV.

The content server actively pushes the content, which classifies into categories, to the host device or TV and save all the content into the host device or TV locally. The server will broadcast the content to all connected host device or TV with or without Internet access or any network access. Therefore, since all the content are saved in the host device or TV locally, it doesn't need to communicate with the server for rendering the content, unless the server has updated content to be pushed to the host device or TV. Alternatively, the content server also may be requested by the requesting module of the host device/TV to push the content.

This is followed by a fourth step of storing the contents locally in a cloud system or server based storage system, by the TV. The method is continued by a fifth step of defining time interval by the manufacturer at which the TV transmits signals of queries to the smartphone. Alternatively, the time interval is adjusted by a user at which the TV transmits signals of queries to the smartphone. This is followed by a sixth step of transmitting the signals of queries wirelessly to the smartphone, at the time interval, for collecting user particulars of the smartphone, by the TV. The method is continued by a seventh step of receiving the signals of queries in the transmission range, by the smartphone. This is followed by an eighth step of responding wirelessly to the TV, with the particulars, by the smartphone. This is followed by a ninth step of recording the particulars, by the TV. The method is continued by a tenth step of setting criteria in the TV for identifying eligible smartphone. This is followed by an eleventh step of distinguishing eligible smartphone from passer-by smartphone, by the TV. This is followed by a twelfth step of prioritising the categories by sorting the categories according to a matching fraction, which is a quotient of number of eligible smartphone having a particular which matches the category, divided by total number of eligible smartphone. The method concludes with a thirteenth step of outputting selected contents, by the TV, according to priorities of categories to which the contents belong.

Frequency of Ping Signal

The frequency of the host device that will be sending out the ping signal can be adjusted e.g. every 5 mins using this module. The reported information from terminal devices such as user specifics, MemberID, IMEI and the timestamp are recorded by the host device.

Eligible Target Audience

In order to distinguish whether the reported devices are eligible target audience or simply walking pass the defined coverage from the host device, the host device is deployed with a criteria to identify target audience by using this module.

In view of the fact that volume of sphere is V=(4/3)πr³. Assuming the radius (r) of the sphere is 10 meters where the centre point is where the host device located, the coverage from the host device is therefore (4/3)π10³.

Furthermore, since the timestamp for the corresponding MemberID/IMEI from terminal devices is recorded for each ping, the host device can check if a specific terminal device is an eligible target audience by checking if such user info appears in two consecutive pings.

For example, if a mobile device is first time detected, the specific user information will be stored but the module or system will not be able to be identified as eligible target audience. Then, if the terminal device is second time detected in a consecutive ping, then the module or system will be able to be identified as target audience. However, if the terminal device is not detected on the consecutive ping, the user info will be discarded by the module or system.

Therefore, we can conclude that:

Target audience=Located within (4/3)πr³ for 2 consecutive pings

Content Prioritization Mechanism

The content to be provided by the host device is defined into different categories e.g. Cat 1=Male, Cat 2=Female, Cat 3=age 15-20, Cat 4=Music, Cat 5=Sports Cat N.

For each category in each ping:

Number of matched type of user specific÷total number of target audience=% matched

e.g.

10÷10=100% (% matched)

5÷10=50%

4÷10=40%

0÷10=0%

Thus, the priority for each category can be determined by sorting the “% matched”. Assuming there are 10 categories (Cat 1-10):

TABLE 1

| Category | % matched | Priority |
|---|---|---|
| 1 | 27% | 8 |
| 2 | 70% | 5 |
| 3 | 65% | 6 |
| 4 | 90% | 2 |
| 5 | 10% | 10 |
| 6 | 89% | 3 |
| 7 | 100% | 1 |
| 8 | 35% | 7 |
| 9 | 15% | 9 |
| 10 | 85% | 4 |

The priority can therefore be determined as in table 2 based on the table 1 above:

TABLE 2

| Priority | Category |
|---|---|
| Priority 1 | Cat 7 |
| Priority 2 | Cat 4 |
| Priority 3 | Cat 6 |
| Priority 4 | Cat 10 |
| Priority 5 | Cat 2 |
| Priority 6 | Cat 3 |
| Priority 7 | Cat 8 |
| Priority 8 | Cat 1 |
| Priority 9 | Cat 9 |
| Priority 10 | Cat 5 |

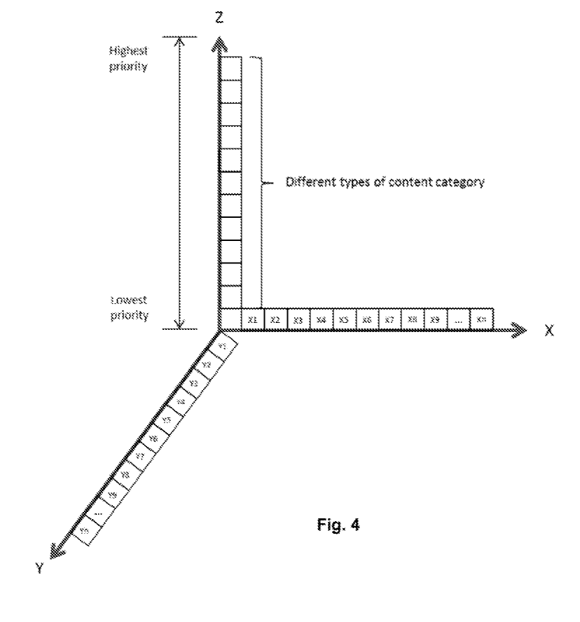

As illustrated in FIG. 4, the host device can therefore select the type of content category to be shown based on the priority worked out as above.

Priority Z=%(Xn,Yn)

Higher the % matched=higher the priority

### Where

Z=priority of preference, where priority to be chosen to show on host device.

Xn=category of content on terminal device.

Yn=category of content on server.

The present invention may be embodied in other specific forms without departing from its essential characteristics. The described embodiments are to be considered in all respects only as illustrative and not restrictive. The scope of the invention is, therefore indicated by the appended claims rather than by the foregoing description. All changes, which come within the meaning and range of equivalency of the claims, are to be embraced within their scope.

I claim:

1. A host device for automatically customizing and displaying output of at least one content within a predefined geographical location, comprising:
a storage module for storing categorized content received from server in said host device locally;
a transceiver module for transmitting ping signals to at least one terminal device at a time interval and for collecting one or more user particulars from said terminal device;
an eligible device identification module for defining criteria for identifying eligible terminal device;
a prioritization module for prioritizing the categorized content stored locally in said host device based upon a matching fraction of a category of said categorized content relating to number of said eligible terminal device having a user particular which matches a category of the categorized content;
a selection module for selecting said content based upon said prioritizing result; and
a display module for displaying said selected content.

2. The host device of claim 1, wherein said storage module is configured to receive categorized content from server through internet at any time so as to allow local storage of up-to-date categorized content.

3. The host device of claim 1, wherein said storage module is configured to receive categorized content from cloud server wirelessly.

4. The host device of claim 1, wherein said categorized content comprises at least one of audio, visual or audiovisual content.

5. The host device of claim 1, wherein said categorized content comprises at least one of television commercials, event, lifestyle information or any combination thereof.

6. The host device of claim 1, wherein said transceiver module is configured to transmit at a time interval of 5-10 minutes.

7. The host device of claim 1, wherein said transceiver module is configured to transmit wireless signal with a pre-determined transmission range.

8. The host device of claim 7, wherein said transceiver module is configured to transmit wireless signal by means of Wi-Fi, ultrasound, infra-red or Bluetooth.

9. The host device of claim 1, wherein said terminal device comprises a user interface to obtain at least one information to be transmitted to the host device.

10. The host device of claim 9, wherein said user interface comprises an application with audience demographic form.

11. The host device of claim 10, wherein said audience demographic form comprises at least one category information from demographics, preference and hobbies.

12. The host device of claim 1, wherein said eligible device identification module is configured to record information specific to said terminal device comprising at least one of member ID, international mobile equipment identity and timestamp at which the user logs in to the system.

13. The host device of claim 1, wherein said eligible device identification module is configured to identify eligible terminal device based upon frequency that a terminal device is detected by said ping signals.

14. The host device of claim 13, wherein said eligible device identification module is configured to identify eligible terminal device based upon further detection by two consecutive ping signals.

15. The host device of claim 1, wherein said prioritization module is configured to calculate the matching fraction of a category of said categorized content by dividing number of said eligible device having a particular which matches said category by total number of said eligible terminal device.

16. The host device of claim 1, wherein said selection module is configured to select the type of categorized content stored in the storage module.

17. The host device of claim 1, further comprising a requesting module, wherein said requesting module is configured to request the server to deliver categorized content to storage module.

18. The host device of claim 1, wherein the terminal device is a handheld computing device.

19. A method for automatically customizing and displaying output of at least one categorized content within a predefined geographical location, comprising steps of:
receiving said categorized content from a server by a host device;
storing said categorized content locally by the host device using a storage module;
identifying at least one eligible terminal device located within said geographical location by the host device using an eligible device identification module;
collecting one or more user particulars by the host device from said eligible terminal device using a transceiver module;
prioritizing said categorized content based upon a matching fraction of a category of said categorized content relating to number of said eligible terminal device having a user particular which matches a category of the categorized content using a prioritization module in the host device;
selecting said categorized content based on said prioritizing result; and
outputting said selected content to a display.

20. The method of claim 19, wherein the step of receiving said categorized content from a server comprises receiving said categorized content at any time from a content server through internet or from a cloud server.

21. The method of claim 19, wherein the step of identifying at least one eligible terminal device located within said geographical location comprises steps of:
detecting terminal device by transmitting ping signals within said geographical location at a time interval;
recording information specific to said terminal device comprising at least one of member ID, international mobile equipment identity and timestamp at which the user logs in to the system; and
identifying eligible terminal device based upon number of times that a terminal device is detected by said ping signals.

22. The method of claim 21, wherein the step of detecting terminal device by transmitting ping signals comprises transmitting wireless signals with a pre-determined transmission range.

23. The method of claim 22, wherein said transmitting wireless signals comprises transmitting wireless signals by means of Wi-Fi, ultrasound, infra-red or Bluetooth.

24. The method of claim 21, wherein the step of detecting terminal device by transmitting ping signals at a time interval comprises transmitting said ping signals at a time interval of 5 to 10 minutes.

25. The method of claim 21, wherein the step of identifying eligible terminal device based upon number of times that a terminal device is detected by said ping signals comprises steps of:
detecting terminal device in two consecutive pings; and
recording said terminal device as an eligible terminal device.

26. The method of claim 19, wherein the step of collecting one or more user particulars from said eligible terminal device comprises steps of:
requesting said eligible terminal device to send user particulars inputted by users in interfaces of said eligible terminal device;
receiving said user particulars; and
recording said user particulars.

27. The method of claim 26, wherein the step of requesting said eligible terminal device to send user particulars inputted by users in interfaces of said eligible terminal device comprises requesting said eligible terminal device to send information filled in by users in an audience demographic form of an installed application of said eligible terminal device.

28. The method of claim 27, wherein said requesting said eligible terminal device to send information filled in by users in an audience demographic form comprises requesting said eligible terminal device to send at least one information from demographics, preference and hobbies as defined in said audience demographic form.

29. The method of claim 26, wherein said receiving said user particulars comprises receiving said user particulars through wireless signals.

30. The method of claim 19, wherein the matching fraction of a category of said categorized content is calculated by dividing the number of said eligible device having a particular which matches said category by total number of said eligible terminal device.

31. The method of claim 19, further comprising steps of:
requesting said server to deliver categorized content to the host device;
prioritizing said newly delivered categorized content based upon said user particulars collected;
selecting said categorized content based upon said prioritizing result; and
outputting said selected content to a display.

32. The method of claim 19, further comprising steps of:
updating list of eligible terminal device identified at a particular point of time;
updating user particulars collected based upon said updated list of eligible terminal device;
prioritizing said categorized content based upon said updated user particulars collected;
selecting said categorized content based upon said prioritizing result; and
outputting said selected content to a display.

33. A system having at least one terminal device, at least one server and a host device for automatically customizing output of at least one content within a predefined geographical location, wherein said host device comprising:
a storage module for storing categorized content received from server in said host device locally;
a transceiver module for transmitting signal wirelessly to terminal device located within a transmission range of said host device at a time interval and for collecting one or more user particulars from said terminal device;
an eligible device identification module for defining criteria for identifying eligible terminal device;
a prioritization module for prioritizing the categorized content stored locally in said host device based upon a matching fraction of a category of said categorized content relating to number of said eligible terminal device having a user particular which matches a category of the categorized content;
a selection module for selecting type of content corresponding to the said prioritizing result; and
a display module for displaying said selected content.
